(19) United States
(12) Patent Application Publication
(10) Pub. No.: US 2020/0298110 A1
(43) Pub. Date: Sep. 24, 2020

(54) Universal Game Controller Remapping Device

(71) Applicant: Eric Alan Koziel, Lexington, MA (US)

(72) Inventor: Eric Alan Koziel, Lexington, MA (US)

(21) Appl. No.: 16/825,344

(22) Filed: Mar. 20, 2020

Related U.S. Application Data
(60) Provisional application No. 62/821,226, filed on Mar. 20, 2019.

(51) Int. Cl. A63F 13/42; A63F 13/71; A63F 13/23

(52) U.S. Cl. CPC A63F 13/42; A63F 2300/6045; A63F 13/23; A63F 13/71

(57) ABSTRACT

A remapping device and method for connecting a game controller to a game console providing an input handler function; an output handler function, a remapping function, an output reporting function, an authenticated output reporting function, a macro function and/or a macro check function.

### RELATED APPLICATIONS

This application claims the benefit under 35 USC 119(e) of U.S. Provisional Application No. 62/821,226, filed on Mar. 20, 2019, which is incorporated herein by reference in its entirety.

### BACKGROUND OF THE INVENTION

Video games are a popular modern hobby where game players can interact with a game program running on specialized or general-purpose computational gaming hardware. Players rely on a type of human interface device called video game controllers to interpret and send commands to the gaming hardware. However, many video game controllers are only compatible with one or a few types of gaming hardware. This means that players are restricted in their choice of video game controllers to interact with specific gaming hardware.

In addition, some players may have impairments or predilections that prevent them from comfortably or effectively using controllers compatible with their targeted gaming hardware.

Additionally, many game players engage in competitive activities involving video game performances. In some cases, players attempt to reach a goal in the shortest amount of time. In others, players attempt to reach a maximum score or other metric. In still others, players compete directly against one another in a contest of skill. For these types of cases, rules are usually established that govern gameplay performance for fairness. Rules may include restrictions on the types of commands that a player can use to interact with gaming hardware, as well as restrictions on assistive tools used over the course of a gameplay session.

### SUMMARY OF THE INVENTION

The present device can be used to alleviate compatibility issues by allowing potentially any video game controller to effectively be used with potentially any gaming hardware. It also can provide a specialized macro and input remapping functionality to further assist players in interacting with gaming hardware in ways that allow them to play comfortably and with a high degree of precision.

In addition, many video game competitions have no means of verifying that a player did not surreptitiously violate the rules of the competition. The present device can be used to log and report all commands that a player sends to gaming hardware from their controller. This log can be cryptographically signed by the system. This signed log of the commands can be submitted to governing bodies of these competitions as proof that the performance occurred, and that the performance complies with any rules on controller commands and assistive tools. The governing body can then independently verify that the log was generated by an authorized universal game controller remapping device and that the log had not been tampered.

The present game controller remapping device concerns an electronic human interface device (HID) interpreter device. This device often utilizes interchangeable adapters that connect to commercial, third-party video game HIDs called controllers. Examples of commercial HIDs include Nintendo Gamecube Controllers, Sony DualShock Controllers, computer mice, and keyboards. An HID is connected to an adapter built to accept the proprietary connectors, electrical signals and protocols of that HID. That adapter is then connected to an embedded computing device, referred to as a converter, which interprets the signals of the HID that encode the user's commands and transforms them into generalized control data. The converter then applies user-configured transformations to the control data. Transformations might include changes to direction, magnitude, and function of controls. A commercial, third-party video game device, called a console, is connected to a separate adapter that is built to accept the proprietary electrical signals and protocols of that console. Examples of commercial gaming devices include Nintendo Gamecube, Sony PlayStation 2, Microsoft Xbox 360, and Microsoft Windows personal computers. The converter sends the transformed, generalized control data to the console through this adapter so that the user commands will be received in the protocol required by the console.

The HID and console need not be natively compatible, and in fact can be changed to other varieties of HID or console by selecting a different, interchangeable adapter. Additionally, the converter can be connected to a user-operated computing device. Examples of computing devices include Microsoft Windows personal computer, Apple iPhone, or a SD flash memory card.

When connected and configured to do so, the converter can perform a variety of different actions. For example, it can provide logs of the user command inputs performed by a user over the course of a gameplay session, and any transformations performed on those inputs. It might also optionally provide authentication of the logs with the use of cryptographic signatures, which make the logs suitable for independent verification and serve to mitigate cheating. These logs could be submitted to verifying entities as proof that the user accomplished a particular session and that the actions and transformations applied comply with any rules for competition related to that session. Examples of gaming competitions include high-score competitions, time attack competitions, and player vs player tournaments.

In general, according to one aspect, the invention features a remapping device for interfacing between a game console controller and a game console. This remapping device comprises a controller connector for connecting to the game console controller, a game console connector for connecting to the game console, and a converter for remapping input from the controller connector to the game console connector based on a type of the game console controller and a type of the game console.

The type of the game console controller, for example, could be one of: Nintendo NES Controller, Nintendo Super NES Controller, Nintendo Nintendo64 Controller, Nintendo Gamecube Controller, Atari VCS Controller, Sega Master System Controller, Sega Genesis Controller, Sega Saturn Controller, Sega Dreamcast Controller, Sony Playstation Controller, Sony DualShock Controller, Sony PlayStation2 Controller, Sony PlayStation3 Controller, Sony PlayStation4 Controller, 8bitdo Controllers, Nintendo Wii Remotes, Nintendo Switch JoyCons, Microsoft Xbox Controllers, Microsoft Xbox 360 Controllers, Microsoft Xbox One Controllers, Logitech Controllers, computer mouse, keyboard.

The type of the game console, for example, could be one of: Nintendo NES, Nintendo Super NES, Nintendo Nintendo64, Nintendo Gamecube, Atari VCS, Atari 2600, Atari 5200, Atari 7800, Atari 800, Sega Master System, Sega Genesis, Sega Saturn, Sega Dreamcast, Sony PlayStation, Sony PlayStation2, Sony PlayStation3, Sony PlayStation4, Nintendo Wii, Nintendo Switch, Microsoft Xbox, Microsoft Xbox 360, Microsoft Xbox One, Microsoft Windows personal computer, Apple Macintosh personal computer, Linux personal computer, Hyperkin RetroN 5, Analogue Super Nt.

In some examples, the remapping device executes macros based on commands received from the game console controller.

The remapping device can also possibly log commands received from the game console controller and/or sent to the game console and also possibly cryptographically signs the log of the commands.

In some embodiments, the device comprises an input adapter having the controller connector and an input adapter converter connector for connecting to the converter, an output adapter having the game console connector and an output adapter converter connector for connecting to the converter, and separate housings for each of the input adapter, output adapter, and converter.

An input electrical conversion circuit can be used to transform electrical signals from the game console controller encoding user command inputs and received via the controller connector to be electrically compatible with the converter. An output electrical conversion circuit can transform electrical signals from the converter to be electrically compatible with the game console.

In general, according to another aspect, the invention features a method for interfacing between a game console controller and a game console. This method comprises receiving a user command inputs from the game console controller and translating signals encoding the user command inputs and sending the translated signals to the game console.

In general, according to still another aspect, the invention features a system and method for connecting a game controller to a game console providing an input handler function, an output handler function, a remapping function, an output reporting function, an authenticated output reporting function, a macro function and/or a macro check function.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram showing a universal game controller remapping device for a console and controller, according to the present invention;

FIG. 2 is a block diagram showing the components of the input adapter 200;

FIG. 3 is a block diagram showing the components of the output adapter 300;

FIG. 4 is a block diagram showing an embodiment in which both the input adapter 200 and output adapter 300 are combined in one physical housing;

FIG. 5 is a block diagram showing the components and organization of the converter 100;

FIG. 6 is a memory map showing the contents of the system memory 130;

FIG. 7 is a flow diagram showing two main computational processes executed on the microprocessor 120;

FIG. 8 is a swimlane diagram showing the setup check function 510 and its interactions of FIG. 7;

FIG. 9 is a swimlane diagram showing the operation of the input handler function 520 of FIG. 7;

FIG. 10 is a swimlane diagram showing the operation of the output handler function 620 of FIG. 7;

FIG. 11 is a swimlane diagram showing the interactions of the remapping function 550 of FIG. 7;

FIG. 12 is a swimlane diagram showing the interactions of the system macro check function 530 of FIG. 7,

FIG. 13 is a swimlane diagram showing the interactions of the macro check function 540 of FIG. 7;

FIG. 14 is a schematic diagram showing is a high-level example of creating, distributing, and verifying a message and signature;

FIG. 15 is a swimlane diagram showing the authenticated output reporting function 660;

FIG. 16 is a swimlane diagram showing the method for a user to verify the authenticity of a message and signature; and

FIG. 17 is a swimlane diagram showing the process of provisioning a device by the manufacturer 94 prior to distribution.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The primary purpose of the universal game controller remapping device is to facilitate and manipulate communications and particularly user command inputs between a HID and some gaming hardware. Video game players manipulate the HID to change its state to generated user commands, and gaming hardware requests those states through a proprietary set of electronic communication protocols. However, an arbitrary HID may not have a physical connector compatible with the target gaming hardware. Additionally, the HID may not support the protocols and command encoding of the target gaming hardware, or may not be electrically compatible with the signals emanating from the gaming hardware. The universal game controller remapping device solves these issues by providing adapters that support the physical and electrical connection of the HID and console to a computing device called a converter 100. This converter 100 is capable of communicating with both the HID and gaming hardware using their respective supported protocols. Additionally, the converter is capable of manipulating the commands it receives according to protocol needs and user preference.

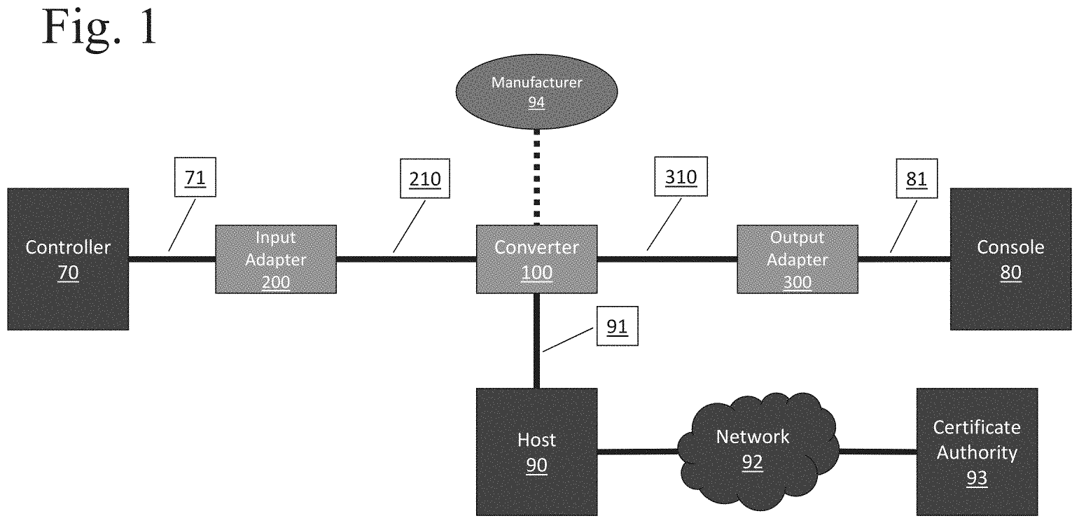

As shown in FIG. 1, the universal game controller remapping device is typically comprised of three major components: an input adapter 200, an output adapter 300, and an electronic computational device referred to herein as a converter 100.

In addition to these components, the remapping device interacts with other devices. These devices include an electronic human interface device, referred to as a controller 70, and an electronic video game system, referred to as a console 80. A user-controlled computing system, called a host 90, performs some functions relating to configuration, logging, and log verification. The host 90 typically communicates through a network 92, often a public network such as the internet with a certificate authority 93 to verify identification information and obtain public cryptographic keys. Additionally, the converter 100 is pre-configured with data and cryptographic keys by the device manufacturer 94.

The input adapter 200 is built to communicate using the proprietary electrical signals and communication protocols specified by the controller's 70 manufacturer. The input adapter 200 is intended to be used with commercial human interface devices, and, often, a particular model of the input adapter 200 is built to interact with just that particular type of controller 70. Examples of commercial human interface devices include Nintendo NES Controller, Nintendo Super NES Controller, Nintendo Nintendo64 Controller, Nintendo Gamecube Controller, Atari VCS Controller, Sega Master System Controller, Sega Genesis Controller, Sega Saturn Controller, Sega Dreamcast Controller, Sony Playstation Controller, Sony DualShock Controller, Sony PlayStation2 Controller, Sony PlayStation3 Controller, Sony PlayStation4 Controller, 8bitdo Controllers, Nintendo Wii Remotes, Nintendo Switch JoyCons, Microsoft Xbox Controllers, Microsoft Xbox 360 Controllers, Microsoft Xbox One Controllers, Logitech Controllers, computer mouse, keyboard. Different models of the input adapter 200 can be freely changed to match different models of controllers 70 at the user's discretion. The controller 70 is connected to the input adapter through the controller connector 71 that is part of the controller's 70 interface specification.

The output adapter 300 is built to communicate using the proprietary electrical signals and communication protocols specified by the console's 80 manufacturer. The output adapter 300 is intended to be used with commercial gaming and computing devices, and, often, a particular model of the output adapter 300 is built to interact with just that particular type of console 80. Examples of commercial gaming and computing devices include Nintendo NES, Nintendo Super NES, Nintendo Nintendo64, Nintendo Gamecube, Atari VCS, Atari 2600, Atari 5200, Atari 7800, Atari 800, Sega Master System, Sega Genesis, Sega Saturn, Sega Dreamcast, Sony PlayStation, Sony PlayStation2, Sony PlayStation3, Sony PlayStation4, Nintendo Wii, Nintendo Switch, Microsoft Xbox, Microsoft Xbox 360, Microsoft Xbox One, Microsoft Windows personal computer, Apple Macintosh personal computer, Linux personal computer, Hyperkin RetroN 5, Analogue Super Nt. Different models of the output adapter 300 can be freely changed to match different models of consoles 80 at the user's discretion. The console 80 is connected to the output adapter through the console connector 81 that is part of the console's 80 interface specification.

A host 90 is usually a user-operated computing system or digital storage medium. Examples include Microsoft Windows personal computer, Apple iPhone, or a SD flash memory card. The host 90 communicates with the converter 100 via a digital communication interface 91. The host also communicates through a network 92, such as the Internet, with the certificate authority 93. The certificate authority 93 is a remote computing platform managed by the manufacturer 94, and provides services that support identity verification. The manufacturer 94 is the entity that assembles and programs the converter 100, including assigning it with unique identifying information.

Many commercial types of controllers 70 require a proprietary connector, strict electrical specifications, and/or a proprietary communication protocol. And the user command inputs will be encoded in unique ways. This limits the number of devices they can natively communicate with. The input adapter 200 is built to support the particular proprietary physical connector of its target controller 70. It additionally alleviates electrical disparities by transforming the electrical signals emanating from the controller 70 into a common electrical format supported by the converter 100.

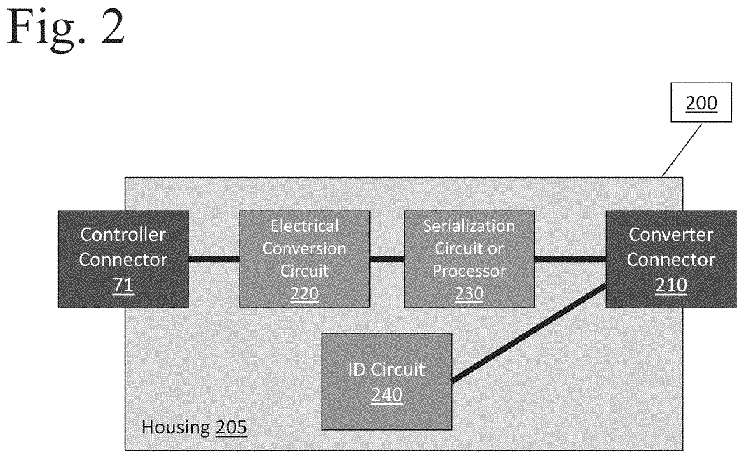

FIG. 2 details the sub-components of the input adapter 200.

An input adapter housing 205 supports a controller connector 71 and a converter connector 210. The electrical conversion circuit 220 performs any transformations necessary to make the electrical signals originating from the controller 70 encoding the user command inputs and received via the connector 71 to be electrically compatible with the converter 100. For example, it might transform 5 volt open-drain signals to 3.3 volt push-pull signals.

The serialization processor 230 performs serialization or de-serialization on the communicated signals. In cases where the communication protocol of the controller 70 has many simultaneous, parallel signals, the serialization processor 230 condenses them into a standard serial protocol to accommodate a fixed, limited number of conductors in the converter connector 210. The converter connector 210 is the physical and electrical connection to the converter 100. Signals arriving via the converter connector 210 from the converter 100 already conform to the particular protocol expected by the controller 70. Signals sent to the controller via the controller connector 71 are therefore compatible with the physical, electrical, and protocol requirements of the controller 70.

The ID circuit 240 provides a signal that uniquely identifies the particular model of input adapter 200. For example, a model of input adapter 200 compatible with the Super Nintendo Entertainment System might produce a signal of 1.33 volts.

Similar to controllers 70, communication with many commercial types of consoles 80 require a proprietary connector, strict electrical specifications, and/or a proprietary communication protocol. This limits the number of devices they can natively communicate with. The output adapter 300 is built to support the particular proprietary physical connector of its target console 80. It additionally alleviates electrical disparities by transforming the electrical signals emanating from the console 80 into a common electrical format supported by the converter 100.

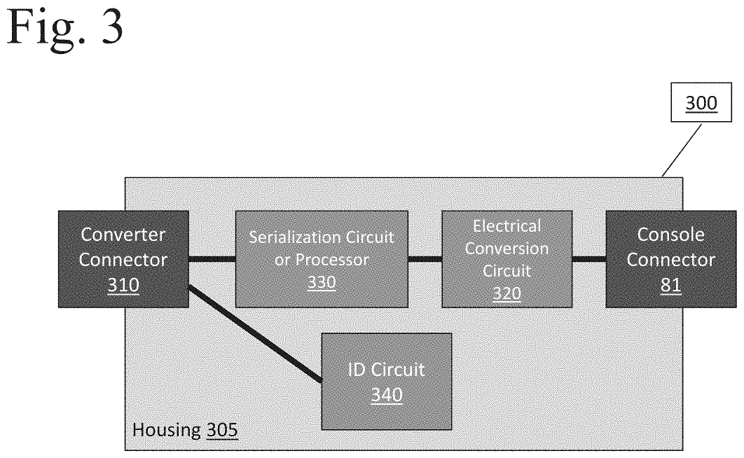

FIG. 3 details the sub-components of the output adapter 300. An output adapter housing 305 supports converter connector 310 and a console connector 81. The electrical conversion circuit 320 performs any transformations necessary to make the electrical signals originating from the console 80 and received via the connector 81 to be electrically compatible with the converter 100. For example, it might transform 5 volt open-drain signals to 3.3 volt push-pull signals.

The serialization processor 330 performs serialization or de-serialization on the communicated signals. In cases where the communication protocol of the console 80 has many simultaneous, parallel signals, the serialization processor 330 condenses them into a standard serial protocol to accommodate a fixed, limited number of conductors in the converter connector 310. The converter connector 310 is the physical and electrical connection to the converter 100. Communication signals arriving at the converter connector 310 from the converter 100 already conform to the particular protocol expected by the console 80. Signals sent to the console via the console connector 81 are therefore compatible with the physical, electrical, and protocol requirements of the console 80.

The ID circuit 340 provides a signal which can uniquely identify the particular model of output adapter 300. For example, a model of output adapter 300 compatible with the Sony PlayStation might produce a signal of 2.5 volts.

In some cases, there are advantages to merging the input adapter 200 and output adapter 300 into a single housing. For example, if a user wanted to use a controller 70 and console 80 pair that mutually supported all aspects of communication, a combined adapter could allow the user to exercise all functions of the universal game controller remapping device while reducing the total number of components the user was required to possess. The user would only need to possess the combined input output adapter 400 for that console 80 and controller 70 pair, rather than a distinct input adapter 200 and output adapter 300 for the controller 70 and console 80, respectively.

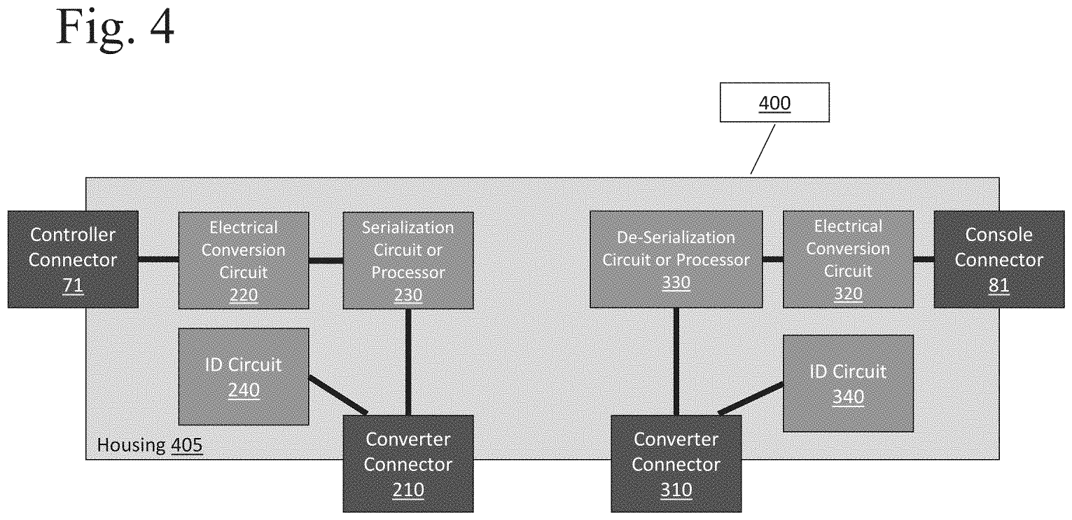

FIG. 4 shows an embodiment in which both the input adapter 200 and output adapter 300 are combined in one physical housing 405, to provide the combined input output adapter 400. All sub-components are the same as described in earlier sections. This configuration has some advantages, such as potentially being able to combine the distinct converter connectors 210 310 and ID circuits 240 340.

The computational ability of the universal game controller remapping device lies in the converter 100. Its primary role is to receive the communication signals from the controller 70 and console 80 via the input adapter 200 and output adapter 300, respectively. The input adapter 200 and output adapter 300 will have transformed the signals to be electrically compatible with the converter 100, and deliver them over standard physical input adapter connector 210 and output adapter connector 310, respectively. Once it receives these signals, it is capable of processing them, and communicating responses as necessary. Processing the signals uses many common computing components, such as a microcontroller 120 and various types of memory. It may also incorporate additional computing entities to increase computation efficiency or expand communication options.

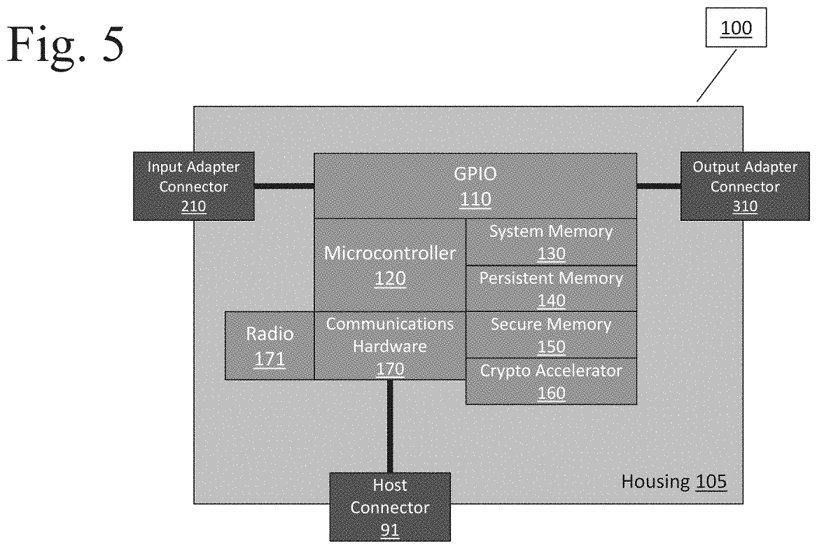

FIG. 5 shows the sub-components and organization of the converter 100. A converter housing 105 supports converter connectors 210, 310 and a host connector 91. A block of general-purpose input-output pins (GPIO) 110 allow electrical communications between other sub-components and the input adapter 200, output adapter 210, and host 90. A general-purpose microcontroller 120 performs calculations based on program instructions and the received signals. System memory 130 is random-access memory (RAM) used for storing computation results. Persistent memory 140 is non-volatile memory used for storing program and configuration data. Secure memory 150 is non-volatile memory that contains sensitive data. A cryptographic accelerator 160 is a special type of processor that can perform specific cryptographic calculations more efficiently than a general-purpose processor. Communications hardware 170 is a special type of processor that can perform specific types of communications more efficiently than or independently from general-purpose processors. A radio 171 is a specific type of communications hardware that allows for wireless communications. This radio 171 allows for communicating with controllers 70, consoles 80, and/or hosts 90 that support wireless communications. Such devices do not need to use their respective adapters or connectors to communicate with the converter 100, and instead will pass all signals through radio waves.

Many computational systems require distinct digital data to operate correctly. For example, a microcontroller 120 requires a set of instructions called a program to operate. These instructions are contained in digital storage mediums known as memory. Additionally, the microcontroller 120 might store temporary variables used as part of calculations into a type of memory. Digital data related to a system's configuration can also be stored in memory.

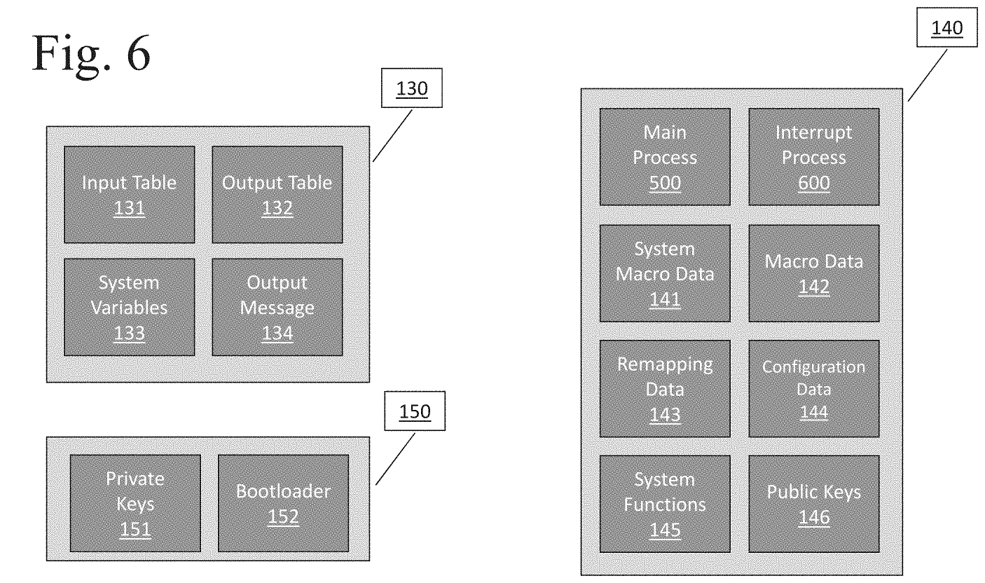

FIG. 6 details the contents of the system memory 130, persistent memory 140, and secure memory 150. Each member within any of the memories can be considered digital data that is accessed as-needed by the microcontroller 120 to execute the main process 500 or interrupt process 600. The secure memory 150 may have additional protections which prevent its contents from being directly accessed, but can instead access those data indirectly to perform specific calculations.

The input table 131 is a data array containing the values of all inputs that have been received. Input data values are assigned to specific addresses based on their function once they are received by the system through the input handler process 520.

The output table 132 is a data array containing the values of all outputs to be sent once a console 80 requests them. Output data values are derived from input table 131 values during the remapping process 550.

System variables 133 are any digital data that help to determine the system's active state, available features, and user preferences.

Output message 134 is a constructed data package containing outputs delivered from the output table 132 and identifying information from the configuration data 144. It may also contain other data from system memory 130 or persistent memory 140.

System macro data 141 is a grouping of data related to identifying whether a user's input has prompted a system macro to execute. System macros require at least one macro trigger and at least one system function. Macro triggers include a set of source addresses and trigger values. System functions include a pointer to a function to execute, for example a function that increments data in system variables 133.

Macro data 142 is a grouping of data related to identifying whether a user's input has prompted a macro to execute. Macros require at least one macro trigger and at least one effect. Macro triggers consist of a set of source addresses and trigger values. Effects consist of destination addresses and values.

Remapping data 143 is the set of instructions describing how to transform specific input table entries 131 corresponding to different user command inputs that were encoded by the controller 70 and received by the input handler 520. These instructions also describe the destination output table entries 132 for the transformed data. The entries in the output table 132 are transformed user command inputs that are later encoded for the game console 80. An instruction is composed of at least a source address, scaling factor, and destination address.

Configuration data 144 is the data describing the converter's 100 unique identity, input handler 520 settings, and output handler 620 settings. Some of this data may be updated by a user or manufacturer to adjust default functions.

System functions 145 are specific functions that users may assign system macros to point to. These functions are small processes that manipulate system state or prompt communications with the host 90.

Public keys 146 are cryptographic keys that are part of an asymmetric encryption algorithm. This data is not sensitive and can be safely accessed or viewed.

Private keys 151 are cryptographic keys that are used as part of an asymmetric encryption algorithm. This data is sensitive and cannot be directly accessed or viewed.

Bootloader 152 is the set of code that the microprocessor 120 first executes after power-on. This code is responsible for setting up relevant system variables 133 and beginning execution of the main process 500. It is considered sensitive, and cannot be directly accessed or viewed after initial execution.

Many computation programs follow sequential execution. This means that after completing execution of one function, it proceeds to execute the next listed function in the program. This proceeds until the program completes execution of all sequentially listed functions, and then it returns to the first function and start over again. This proceeds unless and until the computation system is interrupted. An interrupt is a common type of mechanism in many microcontrollers 120 that can force execution of a specific program or function. The universal game controller remapping device performs a specific program called the main process 500 to collect communications from the controller 70 unless and until it receives a communication request from the console 80. This communication request causes an interrupt to occur, and the microcontroller will temporarily execute an interrupt process 600 program. The interrupt process 600 completes communication with the console 80 and prepares a log of the activity before it returns from the interrupt back to the main process 500.

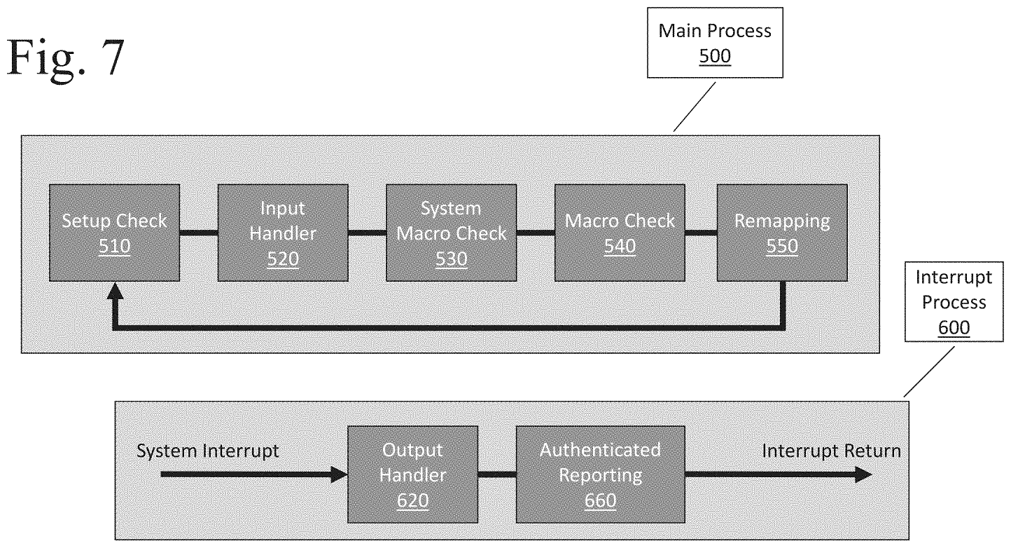

FIG. 7 shows the process flow for the two main computational processes executed on the microprocessor 120. The main process 500 performs a number of functions related to obtaining, acting on, and transforming inputs. The interrupt process 600 performs functions related to transmitting and reporting outputs. Primary execution control follows the main process 500 until a system interrupt occurs, in which case the interrupt process 600 gains execution control. When the interrupt process 600 has finished its member functions, it returns control to the main process 500 via a system interrupt return.

Before the microcontroller 120 can effectively communicate with either the controller 70 or console 80, it needs to identify the particular type of either device it is connected to so that it can select the appropriate communication protocol for interacting with either. This is handled by sampling the ID circuits 240 340 present within the input adapter 200 and output adapter 300, and updating the input configuration and output configuration system variables 133 accordingly. These ID circuits must be sampled regularly so that the microcontroller 120 can identify whether the user has connected a different type of input adapter 200 or output adapter 300 than they had connected previously. Additionally, the microcontroller 120 may need to service commands originating from the host 90 to update its system configuration. All of these tasks are handled by the setup check function 510 which serves as the first function to be executed by the main process 500.

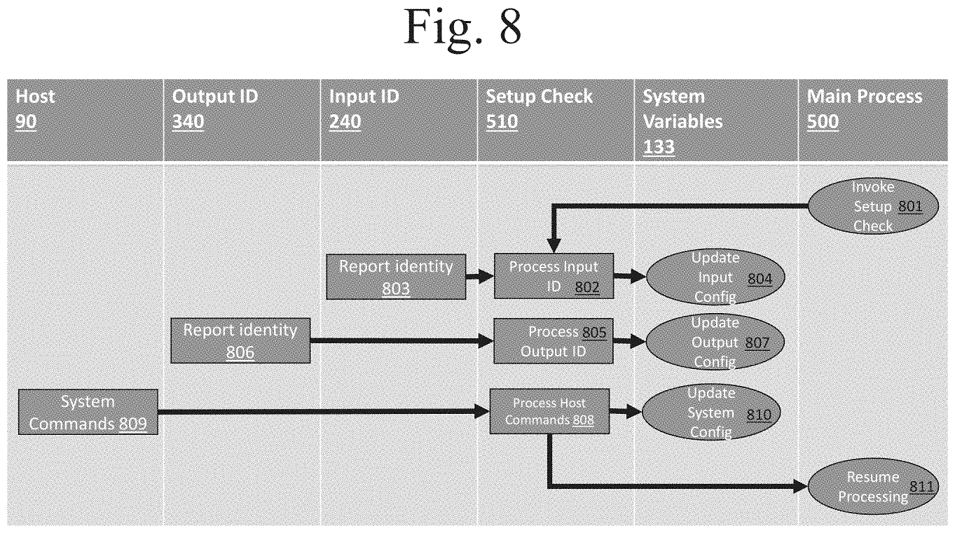

FIG. 8 describes the setup check function 510 and its interactions.

Invoke setup check 801 initiates the setup check function 510 from the main process 500.

Process input ID 802 processes the identity from the input adapter 200 ID circuit 240.

Report identity 803 provides the identity signal to the converter 100 and ultimately setup check function 510.

Update input config 804 manipulates system variables 133 to match the particular model of input adapter 200 determined from process input ID 802.

Process output ID 805 processes the identity from the output adapter 300 ID circuit 340.

Report identity 806 provides the identity signal to the converter 100 and ultimately setup check function 510.

Update output config 807 manipulates system variables 133 to match the particular model of output adapter 300 determined from process output ID 805.

Process host commands 808 processes any received commands from the host 90.

System commands 809 are any specific commands received from the host since the last full execution of the setup check function 510.

Update system config 810 manipulates system variables 133 according to the commands received and processed by process host commands 808.

Resume processing 811 returns execution control from setup check 510 to the main process 500.

Because the setup check function 510 configured the system to use the particular protocol that matches the connected input adapter 200, the microcontroller 120 is capable of processing and responding to signals from the controller 70. The input handler function 520 is responsible for performing this communication. It also collects the status of the controller 70. However, because controller status can be in a proprietary data format, it must be transformed into a common data format. The transformed data is then stored in the input table 131.

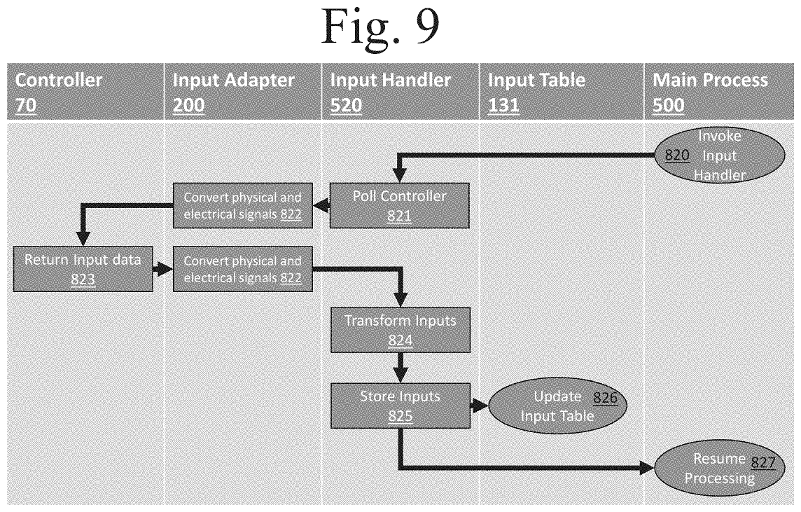

FIG. 9 describes the operation of the input handler function 520 of FIG. 7.

Invoke input handler 820 initiates the input handler function 520 from the main process 500.

Poll controller 821 initiates communications according to the specified protocols of the controller 70.

Convert physical and electrical signals 822 is a bidirectional electrical conversion performed by subcomponents of the input adapter 200 that makes signals to and from the controller 70 electrically compatible with the converter 100.

Return input data 823 is the process the controller 70 uses to determine the state of user inputs and report them back to the converter 100.

Transform inputs 824 manipulates the received inputs according to configuration data 144 for the particular input handler function 520 selected by setup check 510. Each received input is transformed into a value based on its reported state and any scaling factors from configuration data 144.

Store inputs 825 transfers individual inputs to specific addresses according to the particular input handler function selected by setup check 510.

Update input table 826 adjusts data in the input table 131 to match the transformed received inputs.

Resume processing 827 returns execution control from the input handler 520 to the main process 500.

Because the setup check function 510 configured the system to use the particular protocol that matches the connected output adapter 300, the microcontroller 120 processes and responds to signals from the console 80. The output handler function 620 is responsible for performing this communication. However, unlike the input handler 520, the output handler 620 does not initiate requests, and can only respond to requests from the console 80. Because the console is expecting a response with control data in a proprietary data format, it must be transformed from the common data format used by the output table 132 to the proprietary data format the console 80 is expecting. The output handler 620 performs this transformation and transmits the transformed data to the console 80 according to its proprietary communication protocol.

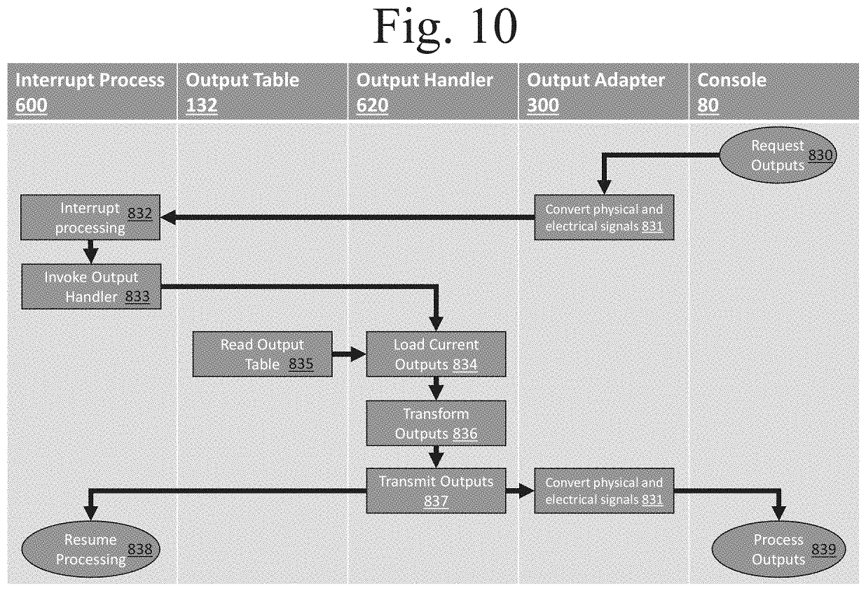

FIG. 10 describes the operation of the output handler function 620 of FIG. 7.

Request outputs 830 is the process the console 80 uses to request inputs from a connected human interface device.

Convert physical and electrical signals 831 is a bidirectional electrical conversion performed by subcomponents of the output adapter 300 that makes signals to and from the console 80 electrically compatible with the converter 100.

Interrupt processing 832 is a means of gaining execution control on the microcontroller 120 from another process, and beginning execution of the interrupt process 600.

Invoke output handler 833 initiates the output handler function 620 from the interrupt process 600.

Load current outputs 834 reads relevant values from the output table 132.

Read output table 835 delivers the values present in all requested addresses of the output table 132.

Transform outputs 836 manipulates the output values according to configuration data 144 for the particular output handler function 620 selected by setup check 510. Each output value is transformed into a new value based on its current value and any scaling factors from configuration data 144.

Transmit outputs 837 sends the transformed output values to the console 80 according to the communication protocol specified by the manufacturers of the console 80.

Resume processing 838 returns execution control from the output handler 620 to the interrupt process 600.

Process outputs 839 is the process used by the console 80 to interpret and act on the received outputs from the output handler 620.

Remapping is a specific feature of the universal game controller remapping device which allows the received user inputs to be transformed into irregular outputs according to a user's configuration. Remapping allows users to freely control their interaction with a console 80 such that they can use the particular input orientation that they are most comfortable with. The remapping function 550 accomplishes this by selectively transferring and transforming input values stored in the input table 131 to the output table 132.

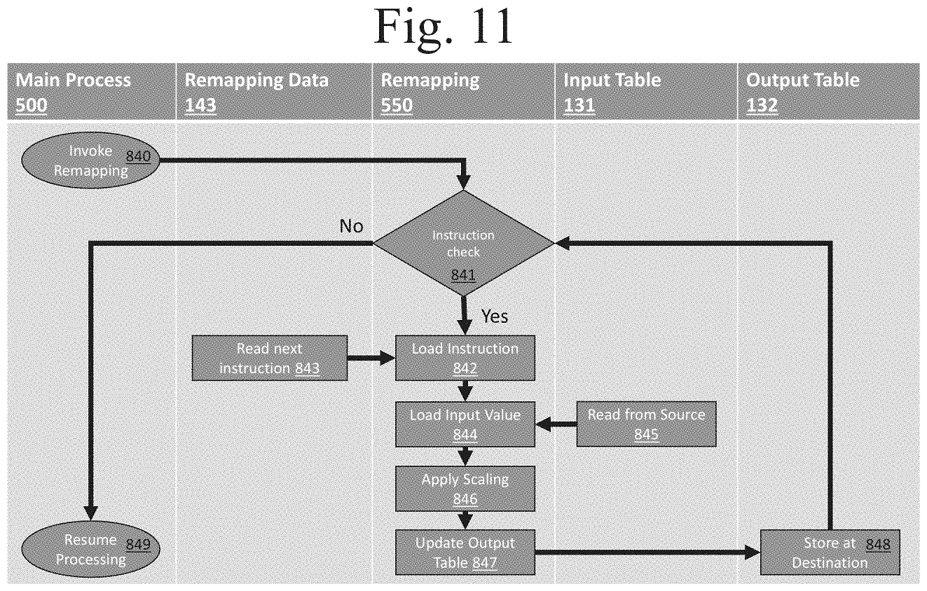

FIG. 11 describes the interactions of the remapping function 550.

Invoke remapping 840 initiates the remapping function 550 from the main process 500 of FIG. 7.

Instruction check 841 assesses whether any more instructions are available to read from the remapping data 143. If more instructions exist, it begins loading the next available instruction from the remapping data. If no more instructions exist, the remapping function 550 returns control to the main process 500.

Load instruction 842 obtains the next instruction consisting of source address, scaling factor, and destination address.

Read next instruction 843 accesses the next available instruction available in the remapping data 143 and provides it to the remapping function 550.

Load input value 844 obtains the value stored in the input table 131 at the source address specified in the instruction.

Read from source 845 accesses the value stored at the source address in the data table 131.

Apply scaling 846 performs a transformation to the data value with the scaling factor from the instruction. For example, it may calculate a new value equal to the product of the data value and scaling factor.

Update output table 847 transfers the transformed data value to the output table 132 to be stored at the destination address specified by the instruction.

Store at destination 848 updates the entry at the destination address of the output table 132 with the new value.

Resume processing 849 returns execution control from the remapping function 550 to the main process 500.

Remapping implies changing the default mapping. To remap, an initial default mapping must be identified. This can be accomplished by organizing different types of inputs by their function and placement across a multitude of different controller 70 types. Using this method allows for the values in the input table 131 to not require any context about what type of controller 70 they originated from. Similarly, it allows for controllers with a similar physical orientation to function similarly when no remapping is specified.

Table 1 shows an example for a controller input map. The Address column is a set of example addresses according to how the inputs might be represented in the input table 131 or output table 132. The Generic column describes the general placement or function of buttons typically assigned to that address. All other columns provide specific examples of commercial controllers 70. Each entry in these columns describes the particular label for an input on that controller 70 matching the function or placement indicated by the generic. A blank entry indicates that the controller 70 does not have an input corresponding to that generic. This table corresponds to how an input table 131 might be filled as input data arrives from a controller 70.

TABLE 1
Example Standard Controller Input Map

| Address | Generic | Atari | NES | SNES | Genesis | N64 | PS2 | Saturn | Gamecube | Switch | PS4 | X360 |
|---|---|---|---|---|---|---|---|---|---|---|---|---|
| 0 | Face 1 | B | B | B | B | A | X | B | B | B | X | A |
| 1 | Face 2 | | A | A | C | B | O | C | A | A | O | B |
| 2 | Face 3 | | | Y | A | Cdown | Sq | A | Y | Y | Sq | X |
| 3 | Face 4 | | | X | X | Cleft | Tr | X | X | X | Tr | Y |
| 4 | Face 5 | | | | Y | Cright | | Y | | | | |
| 5 | Face 6 | | | | Z | Cup | | Z | | | | |
| 6 | Control 1 | | St | St | St | St | St | St | St | Pl | Panel | St |
| 7 | Control 2 | | Sl | Sl | | | Sl | | | Mn | Option | Back |
| 3 | Control 3 | | | | Mode | | Home | | | Home | Home | Home |
| 9 | Control 4 | | | | | | | | | Share | Share | |
| 10 | Shoulder 1 | | | L | | L | L1 | L | L | L | L1 | LB |
| 11 | Shoulder 2 | | | R | | R | R1 | R | R | R | R1 | RB |
| 12 | Shoulder 3 | | | | | | L2 | | | ZL | L2 | LT |
| 13 | Shoulder 4 | | | | | Z | R2 | | Z | ZR | R2 | RT |
| 14 | Shoulder 5 | | | | | | L3 | | | L3 | L3 | L3 |
| 15 | Shoulder 6 | | | | | | R3 | | | R3 | R3 | R3 |
| 16 | Dpad 1 | Up | Up | Up | Up | Up | Up | Up | Up | UpHat | Up | Up |
| 17 | Dpad 2 | Down | Down | Down | Down | Down | Down | Down | Down | DownHat | Down | Down |
| 18 | Dpad 3 | Left | Left | Left | Left | Left | Left | Left | Left | LeftHat | Left | Left |
| 19 | Dpad 4 | Right | Right | Right | Right | Right | Right | Right | Right | RightHat | Right | Right |
| 20 | Axis 1 | | | | | Vert1 | Vert1 | | Vert1 | Vert1 | Vert1 | Vert1 |
| 21 | Axis 2 | | | | | Horiz1 | Horiz1 | | Horiz1 | Horiz1 | Horiz1 | Horiz1 |
| 22 | Axis 3 | | | | | | Vert2 | | Vert2 | Vert2 | Vert2 | Vert2 |
| 23 | Axis 4 | | | | | | Horiz2 | | Horiz2 | Horiz2 | Horiz2 | Horiz2 |

Table 2 is similar to Table 1, however with a remapping applied. These tables are identical except for remapping that has occurred at addresses 16-19. This table corresponds to how an output table 132 might provide data to a console 80 after remapping is has been applied. This particular remapping replaces Dpad inputs with Axis inputs. This means that when the console 80 requests Dpad values from the output handler 620, it delivers transformed Axis1 or Axis2 values. In this example, the transformation of Axis1 to Dpad1 and Axis1 to Dpad2 may differ based on the applied transformation scaling factor, however.

TABLE 2
Example Remapped Controller Outputs

| Address | Generic | Atari | NES | SNES | Genesis | N64 | PS2 | Saturn | Gamecube | Switch | PS4 | X360 |
|---|---|---|---|---|---|---|---|---|---|---|---|---|
| 0 | Face 1 | B | B | B | B | A | X | B | B | 8 | X | A |
| 1 | Face 2 | | A | A | C | B | O | C | A | A | O | B |
| 2 | Face 3 | | | Y | A | Cdown | Sq | A | Y | Y | Sq | X |
| 3 | Face 4 | | | X | X | Cleft | Tr | X | X | X | Tr | Y |
| 4 | Face 5 | | | | Y | Cright | | Y | | | | |
| 5 | Face 6 | | | | Z | Cup | | Z | | | | |
| 6 | Control 1 | | St | St | St | St | St | St | St | Pl | Panel | St |
| 7 | Control 2 | | Sl | Sl | | | Sl | | | Mn | Option | Back |
| 8 | Control 3 | | | | Mode | | Home | | | Home | Home | Home |
| 9 | Control 4 | | | | | | | | | Share | Share | |
| 10 | Shoulder 1 | | | L | | L | L1 | L | L | L | L1 | LB |
| 11 | Shoulder 2 | | | R | | R | R1 | R | R | R | R1 | RB |
| 12 | Shoulder 3 | | | | | | L2 | | | ZL | L2 | LT |
| 13 | Shoulder 4 | | | | | Z | R2 | | Z | ZR | R2 | RT |
| 14 | Shoulder S | | | | | | L3 | | | L3 | L3 | L3 |
| 15 | Shoulder 6 | | | | | | R3 | | | R3 | R3 | R3 |
| 16 | Dpad 1 | Axis1 | Axis1 | Axis1 | Axis1 | Axis1 | Vert1 | Axis1 | Axis1 | Axis1 | Axis1 | Axis1 |
| 17 | Dpad 2 | Axis1 | Axis1 | Axis1 | Axis1 | Axis1 | Vert1 | Axis1 | Axis1 | Axis1 | Axis1 | Axis1 |
| 18 | Dpad 3 | Axis2 | Axis2 | Axis2 | Axis2 | Axis2 | Horiz1 | Axis2 | Axis2 | Axis2 | Axis2 | Axis2 |
| 19 | Dpad 4 | Axis2 | Axis2 | Axis2 | Axis2 | Axis2 | Horiz1 | Axis2 | Axis2 | Axis2 | Axis2 | Axis2 |
| 20 | Axis 1 | | | | | Vert1 | Vert1 | | Vert1 | Vert1 | Vert1 | Vert1 |
| 21 | Axis 2 | | | | | Horiz1 | Horiz1 | | Horiz1 | Horiz1 | Horiz1 | Horiz1 |
| 22 | Axis 3 | | | | | | Vert2 | | Vert2 | Vert2 | Vert2 | Vert2 |
| 23 | Axis 4 | | | | | | Horiz2 | | Horiz2 | Horiz2 | Horiz2 | Horiz2 |

The input handler 520, output handler 620, and remapping function 550 all perform a mathematical transformation on received data so that it is tracked as a standard data format, is compatible with the console's 80 communication protocol, and supports generic remapping instructions, respectively. This transformation depends on the particular datatypes involved, and whether or not scaling is necessary.

The data provided in Table 3 illustrates several types of data transformations. The Input Datatype column specifies the format of data received from the controller 70. Input Data column specifies the value received from the controller 70. Input Table Data column shows the value of the input data when it is stored to the input table 131 as an 8-bit signed value. Scaling factor column provides several example scaling factors that transform the internal data, where each value is a floating point number. Output Table Data column lists the 8-bit signed value obtained from the product of the scaling factor and input table value. Output data column is the value delivered to the console 80 according to the datatype it is expecting listed in the Output Datatype column.

TABLE 3
Data Transformation Example Table

| | | Input Table | | Output | | |
|---|---|---|---|---|---|---|
| | | Data | Scaling | Table Data | | |
| Input | Input | (8-bit | Factor | (8-bit | Output | Output |
| Datatype | Data | signed) | (float) | signed) | Data | Datatype |
| 1-bit | 0 | 0 | .5 | 0 | 0 | 1-bit |
| 1-bit | 1 | 127 | .5 | 63 | 1 | 1-bit |
| 1-bit | 0 | 0 | .5 | 0 | 0 | 8-bit |
| 1-bit | 1 | 127 | .5 | 63 | 63 | 8-bit signed |
| 1-bit | 1 | 127 | −.25 | −32 | −32 | 8-bit signed |
| 8-bit signed | 64 | 64 | .01 | 0 | 0 | 1-bit |
| 8-bit signed | −32 | −32 | −.05 | 1 | 1 | 1-bit |
| 8-bit signed | 100 | 100 | .8 | 80 | 80 | 8-bit signed |
| 8-bit signed | −30 | −30 | 2.0 | −60 | −60 | 8-bit signed |
| 8-bit signed | −50 | −50 | 1.0 | −50 | 0 | 8-bit |
| | | | | | | unsigned |
| 8-bit signed | −50 | −50 | −1.0 | 50 | 50 | 8-bit |
| | | | | | | unsigned |
| 8-bit | 36 | 36 | 1.5 | 54 | 54 | 8-bit signed |
| unsigned | | | | | | |

In some cases, the user may want to alter particular operating functions of the universal game controller remapping device. For example, they may want to toggle a particular mode of operation, increment an internal system variable 133, or prompt communication with a host 90. These tasks can be accomplished through system macros. System macros cause specific system functions to execute when one or more specific inputs are recognized within the input table 131. The specific inputs to activate a specific system function are configured by the user in advance. The system macro check function 520 assesses whether one or more system macros are activated from the user's most recent inputs.

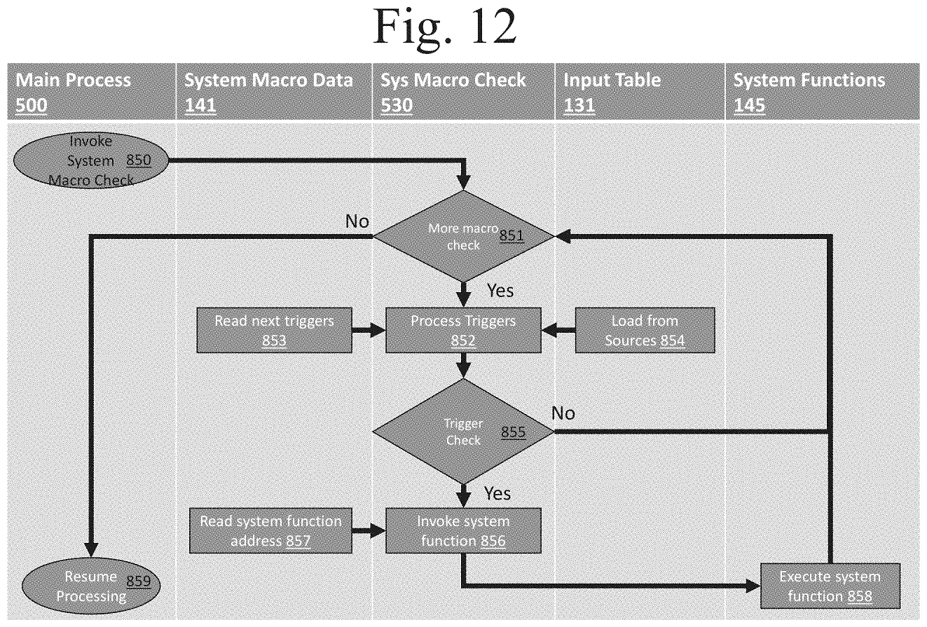

FIG. 12 describes the interactions of the system macro check function 530 of FIG. 7.

Invoke system macro check 850 initiates the system macro check function 530 from the main process 500.

More macro check 851 determines whether further macros exist in system macro data 141 to check. If more macros exist, it begins processing the next system macro. If not, it returns execution control to the main process 500.

Process triggers 852 assesses whether a trigger for the macro has occurred. It obtains the set of triggers from the system macro data 141. A trigger is comprised of a source address and a threshold value. The data value at the entry of the input table 131 specified by the source address is compared with the threshold value to determine whether the trigger is a success. For example, the trigger might be considered a success if the data value is greater than the threshold value.

Read next triggers 853 delivers the set of triggers associated with the particular system macro to the system macro check function 530 from the system macro data 141.

Load from sources 854 delivers the data values at specified source addresses from the input table 131 to the system macro check function 530.

Trigger check 855 assesses whether all prior triggers were successful. If all triggers succeeded, execution proceeds to call the specified system function. If not, execution checks whether there are more system macros to process.

Invoke system function 856 obtains the system function address and initiates the execution of the particular function.

Read system function address 857 delivers the system function address for the current system macro to the system macro check function 530.

Execute system function 858 completes the set of calculations and data manipulations required by the particular system function.

Resume processing 859 returns execution control from the system macro check function 530 to the main process 500.

In some cases, the user may want to force a particular set of outputs to be transmitted to the console 80 regardless of the inputs received from the controller 70. This task can be accomplished through macros. Macros cause specific outputs to be loaded into the output table 132 when one or more specific inputs are recognized within the input table 131. The specific inputs to activate a specific macro are configured by the user in advance. The macro check function 540 assesses whether a macro is activated from the user's most recent inputs.

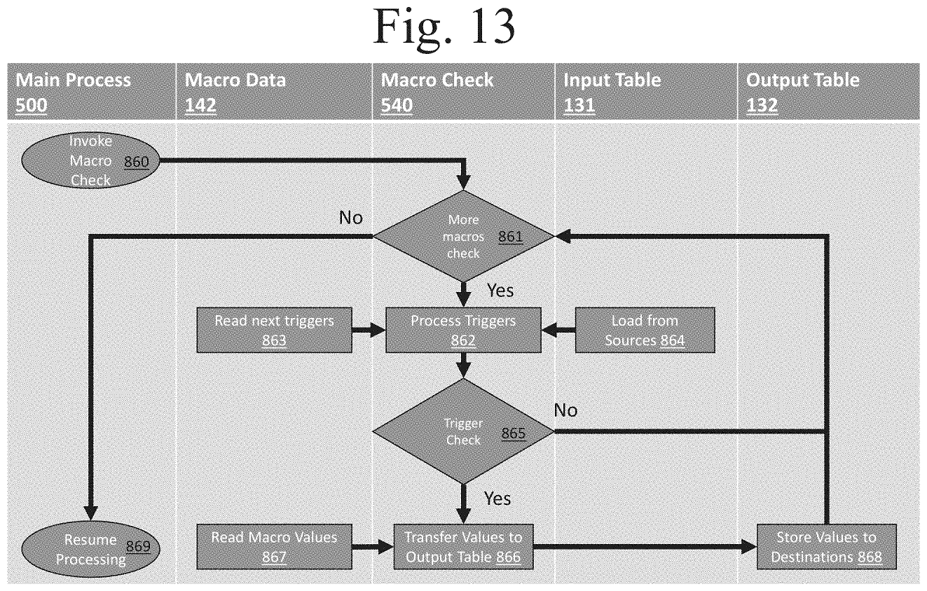

FIG. 13 describes the interactions of the macro check function 540 of FIG. 7.

Invoke macro check 860 initiates the macro check function 540 from the main process 500.

More macros check 861 determines whether further macros exist in macro data 142 to check. If more macros exist, it begins processing the next macro. If not, it returns execution control to the main process 500.

Process triggers 862 assesses whether a trigger for the macro has occurred. It obtains the set of triggers from the macro data 142. A trigger is comprised of a source address and a threshold value. The data value at the entry of the input table 131 specified by the source address is compared with the threshold value to determine whether the trigger is a success. For example, the trigger might be considered a success if the data value is greater than the threshold value.

Read next triggers 863 delivers the set of triggers associated with the particular macro to the macro check function 540 from the macro data 142.

Load from sources 864 delivers the data values at specified source addresses from the input table 131 to the system macro check function 540.

Trigger check 865 assesses whether all prior triggers were successful. If all triggers succeeded, execution proceeds to fill the output table with the macro values. If not, execution checks whether there are more macros to process.

Transfer values to output table 866 obtains the sets of values and destination addresses from the macro data 142. These values are stored into the output table 132.

Read macro values 867 delivers the sets of values and destination addresses for the current macro to the macro check function 540.

Store values to destinations 868 stores the specified values from the macro into the destination addresses of the output table 132.

Resume processing 869 returns execution control from the macro check function 540 to the main process 500.

Cryptographic signatures are a standard approach for assuring data integrity and authenticity. There are many standard protocols for creating and verifying signatures. For example, one protocol might take a message 134 of digital data and encrypt it into a signature 95 using a private key 151. The message and signature can then be released publicly. An entity wishing to verify the signature could then follow the verification process of decrypting the signature using the public key for that signature obtained from a trusted entity. If the decrypted signature matches the message, the verifying entity is assured that the message has not been tampered and that it originated from an authorized device.

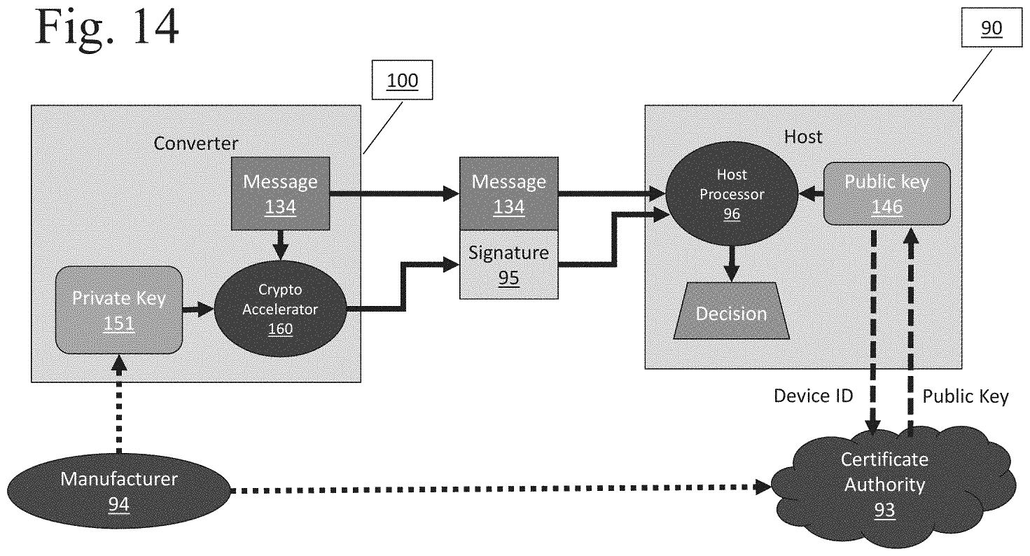

FIG. 14 is a high-level example of creating, distributing, and verifying a message and signature. The converter 100 produces a message 134 containing data related to the current user's activity session. A copy of the message 134 is used to create a cryptographic signature 95 by the crypto accelerator 160 in conjunction with a private key 151. Examples of cryptographic signature algorithms include RSA and Digital Signature Algorithm. The device manufacturer 94 pre-placed the private key 151 in the converter during manufacturing time, and distributed a matching public key 146 to the certificate authority 93. The message 134 and signature 95 are delivered to the host 90. Using identifying information in the message 134, the host 90 requests and receives the public key 146 from the certificate authority 93. The host 90 then uses their own computing processor 96 to perform cryptographic verification on the message 134 and signature 95. If the verification is successful, the user knows that the message 134 has not been tampered, and that it came from an authorized converter 100.

The main data that a verifying entity wants to verify is that a gameplay session was performed according to the particular rules of competition. This is accomplished by reporting what user command inputs and corresponding control data is sent to the console 80 in response to its requests in a data package called a message 134. Other data, such as identification information for the converter 100 and configuration data 144, may also be included for additional assurance. However, a user or malicious actor could tamper or spoof this data. This is why generating a cryptographic signature 95 is necessary to protect against such attacks. The authenticated output reporting function 660 generates this message 134 and signature 95, and transmits it to a host 90 for further distribution.

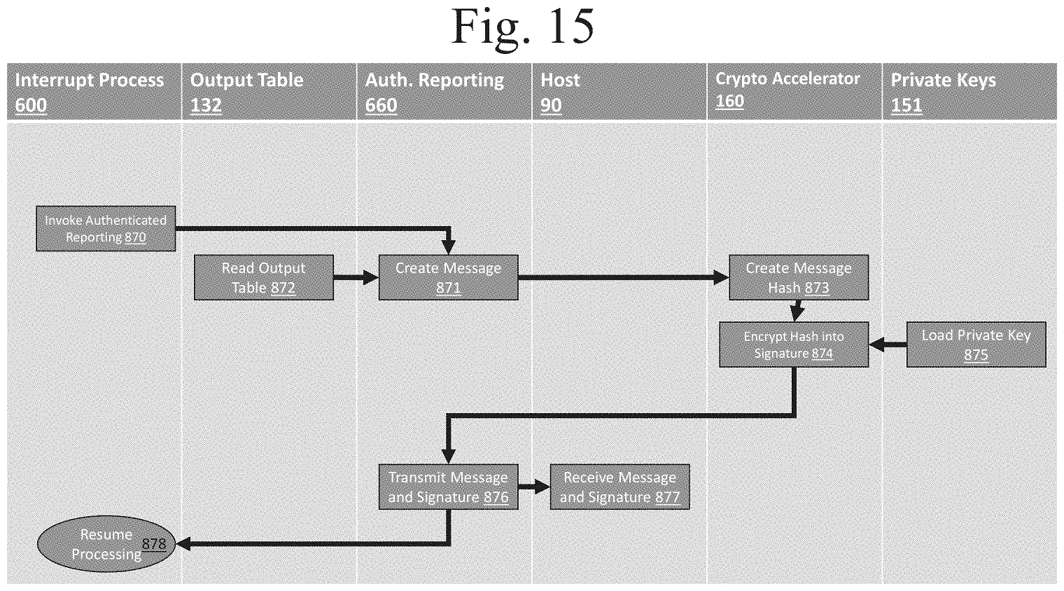

FIG. 15 illustrates the authenticated output reporting function 660.

Invoke authenticated reporting 870 initiates the authenticated reporting 660 processing through standard microcontroller function calls.

Create message 871 forms a message 134 composed of data from the output table 132 and other device identification and configuration data. The message 134 is digital data.

Read output table 872 is the particular method used to access digital data from the output table 132.

Create message hash 873 creates a cryptographic hash using the cryptographic accelerator. Examples of cryptographic hashing algorithms include Secure Hashing Algorithm and MD5.

Encrypt hash into signature 874 uses a cryptographic signature algorithm with the private key 151 to encrypt the message hash. Examples of cryptographic signature algorithms include RSA and Digital Signature Algorithm.

Load private key 875 is the particular method used to access digital data from the private keys 151.

Transmit message and signature 876 sends the message and signature data to the host 90 through an available digital communications or storage medium.

Receive message and signature 877 obtains the message and signature for the particular activity session.

Resume processing 878 returns execution control from the authenticated output reporting function 660 to the interrupt process 600.

Obtaining a message 134 and signature 95 alone is not enough to prove that the message 134 is authentic and has not been tampered. A verifying entity must follow a verification process to determine these properties. The entity can use its own computing resources to accomplish this in conjunction with a specific public key 146 for the particular converter 100 obtained from a trusted entity such as a certificate authority 95.

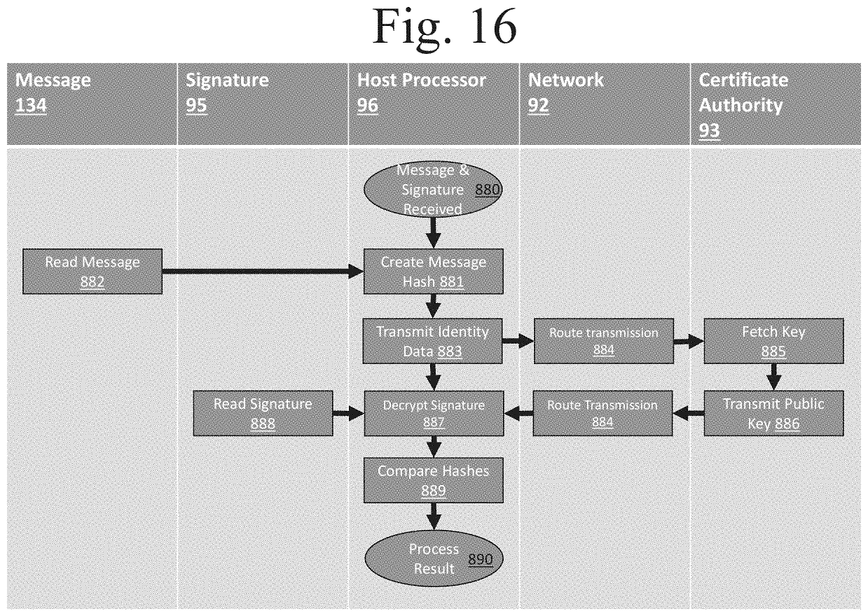

FIG. 16 describes a method for a user to verify the authenticity of a message and signature.

Message and signature received 880 is directly equivalent to receiving the message and signature 877. The host 90 obtains a copy of the message 134 and signature 95 by any means.

Create message hash 881 processes a copy of the message 134 using the same cryptographic hashing algorithm used to create the signature 95.

Read message 134 loads the digital data from the message 134, including identity data.

Transmit identity data 883 sends the identity data obtained from the message 134 to the certificate authority 93.

Route transmission 884 is the process of using network routing protocols to communicate with a remote entity connected to the network 92. An example of a network is the Internet and its associated standard protocols.

Fetch key 885 assesses the identity data received by the certificate authority 93 and selects the public key that matches this data.

Transmit public key 886 sends the matching public key back over the network 92 to the host 90.

Decrypt signature 887 performs the computations necessary to decrypt the signature 95 using the public key 146 obtained from the certificate authority 93. This decrypted signature data is then called hash′. The decryption computations are specified by the verification process of the particular cryptographic signature algorithm employed.

Read signature 888 provides the digital data from the signature 95 to the host processor 96.

Compare hashes 889 compares hash′ with the hash created in create message hash 881 to see if they match.

Process result 890 determines that the message 134 is authentic if both hash and hash′ matched in compare hashes 889. An authentic message 134 provides assurance that it was not tampered and that it was produced by a trusted converter 100. In the context of gameplay sessions, this means that the sequence of outputs provided to a console 80 can be logged and provided by a user as proof that the session was performed.

Since cryptographic signatures rely on keeping the private key 907 secret from the public, including the user of the universal game controller remapping device, care must be taken in generating and storing the private key. The manufacturer 94 for the device must generate a private key 151 and public key 146 pair, and distribute these keys to their respective memories. Additionally it provides the public key 146 and identifying information for the particular device to a certificate authority 93. Verifying entities can request the public key 146 from the certificate authority 93, but can never receive the private key 151. The manufacturer 94 also must take care not to reveal the private key 95.

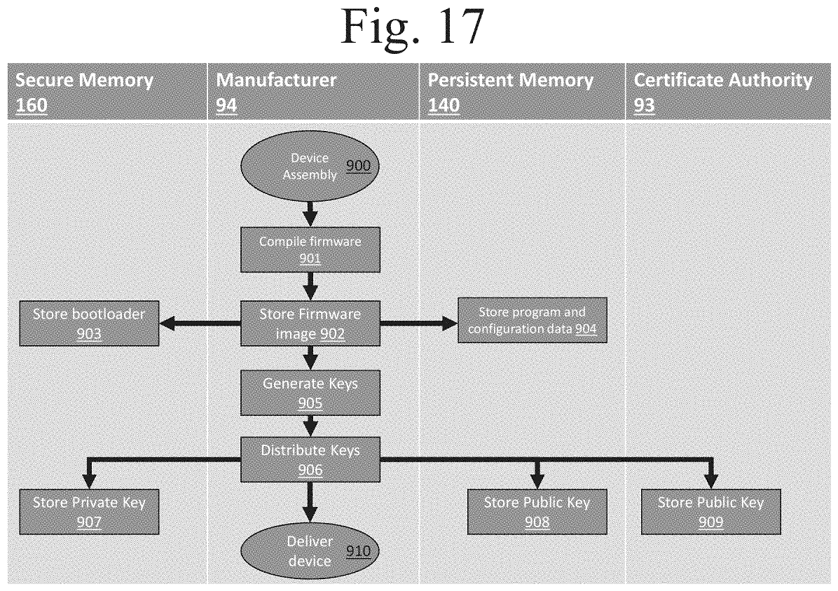

FIG. 17 illustrates the process of provisioning a device by the manufacturer 94 prior to distribution. Secure provisioning practice is necessary to assure that sensitive data such as private keys 151 are not compromised.

Device assembled 900 is the process of constructing the converter 100, including placing components and fabricating housing.

Compile firmware 901 is the software process of generating a firmware image that contains the device's programming and configuration data, including unique identity data. The firmware generation process is specified according to the microcontroller 120 manufacturers.

Store firmware image 902 is the process of writing portions of the firmware data to the persistent memory 140 and secure memory 160.

Store bootloader 903 places the bootloader in secure memory.

Store program and configuration data 904 places the main process 500, interrupt process 600, configuration data 144, and other default data into persistent memory 140.

Generate keys 905 produces a public key 146 and private key 151 pair according to specified procedures for the chosen cryptographic signature algorithm.

Distribute keys 906 sends the cryptographic keys and unique identity data to several sources. The private key 151 is delivered to secure memory 160. The public key 146 is placed in persistent memory 140 and transmitted along with identity data to a certificate authority 93.

Store private key 907 places the private key 151 in the secure memory 160.

Store public key 908 places the public key 146 in the persistent memory 140.

Store public key 909 stores the public key 146 and identity data in a look-up table. If any user provides identity data to the certificate authority 93, it can check this table for matching identity data, and return any associated public key 146.

Deliver device 910 distributes the completed device to end users for their personal use.

While this invention has been particularly shown and described with references to preferred embodiments thereof, it will be understood by those skilled in the art that various changes in form and details may be made therein without departing from the scope of the invention encompassed by the appended claims.

What is claimed is:

1. A remapping device for interfacing between a game console controller and a game console, the remapping device comprising:
a controller connector for connecting to the game console controller;
a game console connector for connecting to the game console; and
a converter for remapping input from the controller connector to the game console connector based on a type of the game console controller and a type of the game console.

2. The device of claim 1, wherein the type of the game console controller is one of: Nintendo NES Controller, Nintendo Super NES Controller, Nintendo Nintendo64 Controller, Nintendo Gamecube Controller, Atari VCS Controller, Sega Master System Controller, Sega Genesis Controller, Sega Saturn Controller, Sega Dreamcast Controller, Sony Playstation Controller, Sony DualShock Controller, Sony PlayStation2 Controller, Sony PlayStation3 Controller, Sony PlayStation4 Controller, 8bitdo Controllers, Nintendo Wii Remotes, Nintendo Switch JoyCons, Microsoft Xbox Controllers, Microsoft Xbox 360 Controllers, Microsoft Xbox One Controllers, Logitech Controllers, computer mouse, keyboard.

3. The device of claim 1, wherein the type of the game console is one of: Nintendo NES, Nintendo Super NES, Nintendo Nintendo64, Nintendo Gamecube, Atari VCS, Atari 2600, Atari 5200, Atari 7800, Atari 800, Sega Master System, Sega Genesis, Sega Saturn, Sega Dreamcast, Sony PlayStation, Sony PlayStation2, Sony PlayStation3, Sony PlayStation4, Nintendo Wii, Nintendo Switch, Microsoft Xbox, Microsoft Xbox 360, Microsoft Xbox One, Microsoft Windows personal computer, Apple Macintosh personal computer, Linux personal computer, Hyperkin RetroN 5, Analogue Super Nt.

4. The device of claim 1, wherein the remapping device execute macros based on commands received from the game console controller.

5. The device of claim 1, wherein the remapping device logs commands received from the game console controller and/or sent to the game console.

6. The device of claim 5, wherein the remapping device cryptographically signs the log of the commands.

7. The device of claim 1, further comprising:
an input adapter having the controller connector and an input adapter converter connector for connecting to the converter;
an output adapter having the game console connector and an output adapter converter connector for connecting to the converter; and
separate housings for each of the input adapter, output adapter, and the converter.

8. The device of claim 1, further comprising an input electrical conversion circuit for transforming electrical signals from the game console controller encoding user command inputs and received via the controller connector to be electrically compatible with the converter.

9. The device of claim 8, further comprising an output electrical conversion circuit for transforming electrical signals from the converter to be electrically compatible with the game console.

10. The device of claim 1, further comprising an output electrical conversion circuit for transforming electrical signals from the game console controller encoding user command inputs and received via the controller connector to be electrically compatible with the converter.

11. A method for interfacing between a game console controller and a game console, the method comprising:
receiving user command inputs from the game console controller; and
translating signals encoding the user command inputs and sending the translated signals to the game console.

12. The method of claim 11, wherein the signals are translated based on a type of the game console controller and a type of the game console.

13. The method of claim 12, wherein the type of the game console controller is one of: Nintendo NES Controller, Nintendo Super NES Controller, Nintendo Nintendo64 Controller, Nintendo Gamecube Controller, Atari VCS Controller, Sega Master System Controller, Sega Genesis Controller, Sega Saturn Controller, Sega Dreamcast Controller, Sony Playstation Controller, Sony DualShock Controller, Sony PlayStation2 Controller, Sony PlayStation3 Controller, Sony PlayStation4 Controller, 8bitdo Controllers, Nintendo Wii Remotes, Nintendo Switch JoyCons, Microsoft Xbox Controllers, Microsoft Xbox 360 Controllers, Microsoft Xbox One Controllers, Logitech Controllers, computer mouse, keyboard.

14. The method of claim 12, wherein the type of the game console is one of: Nintendo NES, Nintendo Super NES, Nintendo Nintendo64, Nintendo Gamecube, Atari VCS, Atari 2600, Atari 5200, Atari 7800, Atari 800, Sega Master System, Sega Genesis, Sega Saturn, Sega Dreamcast, Sony PlayStation, Sony PlayStation2, Sony PlayStation3, Sony PlayStation4, Nintendo Wii, Nintendo Switch, Microsoft Xbox, Microsoft Xbox 360, Microsoft Xbox One, Microsoft Windows personal computer, Apple Macintosh personal computer, Linux personal computer, Hyperkin RetroN 5, Analogue Super Nt.

15. The method of claim 11, wherein the remapping device executes macros based on the user command inputs received from the game console controller.

16. The method of claim 11, further comprising logging the user command inputs received from the game console controller and/or sent to the game console.

17. The method of claim 16, further comprising cryptographically signing the log of the commands.

18. The method of claim 11, further comprising transforming electrical signals from the game console controller encoding the user command inputs to electrically compatible with the game console.

19. A system and method for connecting a game controller to a game console providing an input handler function, an output handler function, a remapping function, an output reporting function, an authenticated output reporting function, a macro function and/or a macro check function.
